(19) United States
(12) Patent Application Publication
(10) Pub. No.: US 2024/0429956 A1
(43) Pub. Date: Dec. 26, 2024

(54) WIRELESS COMMUNICATION SYSTEM AND WIRELESS COMMUNICATION METHOD

(71) Applicant: Mitsubishi Electric Corporation, Tokyo (JP)

(72) Inventor: Kohei SENGA, Tokyo (JP)

(73) Assignee: Mitsubishi Electric Corporation, Tokyo (JP)

(21) Appl. No.: 18/828,496

(22) Filed: Sep. 9, 2024

Related U.S. Application Data
(63) Continuation of application No. PCT/JP2022/018050, filed on Apr. 18, 2022.

(51) Int. Cl. H04B 1/10; H04L 25/02

(52) U.S. Cl. CPC H04B 1/1027; H04L 25/0202

(57) ABSTRACT

A first regular device (300) transmits two first dummy radio waves at different timings. A second regular device (300) transmits a second dummy radio wave at the same timing as the transmission of one of the first dummy radio waves, and transmits the second dummy radio wave at a different timing from the transmission of the other of the first dummy radio waves. A partner device (200) receives a reception radio wave which is the sum of the first dummy radio wave, the second dummy radio wave, and an interference radio wave, receives a reception radio wave which is the sum of the first dummy radio wave and the interference radio wave, receives a reception radio wave which is the sum of the second dummy wave and the interference radio wave, and creates digital filters based on the received three reception radio waves.

### CROSS REFERENCE TO RELATED APPLICATIONS

This application is a Continuation of PCT International Application No. PCT/JP2022/018050, filed on Apr. 18, 2022, all of which is hereby expressly incorporated by reference into the present application.

### TECHNICAL FIELD

The present disclosure relates to wireless communication under communication interference.

### BACKGROUND ART

In wireless communication, an unspecified large number of terminals can access the wireless communication from remote sites as long as a radio wave reaches. Therefore, the wireless communication is susceptible to communication interference due to an interference radio wave, compared to wired communication, and an influence on the communication interference is high. Accordingly, in the wireless communication, a countermeasure against the communication interference is important.

In particular, in a use case where the availability of communication is required, there is a need for technology not only to detect the communication interference, but also to maintain the communication as long as possible even under the communication interference.

Non-Patent Literature 1 discloses a technique to maintain communication under communication interference in an MIMO communication system using a plurality of antennas. Specifically, the following technique is disclosed.

First, each of a component due to a communication radio wave from a regular terminal and a component due to an interference radio wave from an irregular terminal is estimated from channel information on a reception radio wave signal, by an MMSE technique.

The MMSE technique is one of estimation techniques in the MIMO system.

The reception radio wave signal is the sum of the communication radio wave from the regular terminal, the interference radio wave from the irregular terminal, and other noise.

The channel information is a matrix having complex numbers as components, and expresses how the amplitude and phase of a radio wave propagated on a certain path have changed.

Then, a digital filter is created that separates from the reception radio wave signal, a signal of the communication radio wave from the regular terminal, using two pieces of estimated channel information. By application of this digital filter, only the signal from the regular terminal can be received even under the communication interference.

Non-Patent Literature 1 assumes that communication of the regular terminal is randomly stopped for the signal separation. That is, it is assumed that only the interference radio wave from the irregular terminal can be received.

MIMO is an abbreviation for Multiple-Input and Multiple-Output.

MMSE is an abbreviation for Minimum Mean Square Error.

With regard to communication interference by an interference radio wave, there is a technique to indiscriminately continue to emit interference radio waves.

Further, there is also a reactive technique to monitor communication of a regular terminal, and emit an interference radio wave only when a communication radio wave is detected.

### CITATION LIST

### Patent Literature

Non-Patent Literature 1: T. T. Do et al., “Jamming-Resistant Receivers for the Massive MIMO Uplink”, IEEE Transactions on Information Forensics and Security (Volume: 13, Issue: 1, January 2018)

### SUMMARY OF INVENTION

### Technical Problem

In the technique of Non-Patent Literature 1, it is necessary to be able to receive only the interference radio wave for the signal separation. Therefore, the technique of Non-Patent Literature 1 cannot deal with communication interference by the reactive technique that can, even if communication of the regular terminal is randomly stopped, stop action by following the communication of the regular terminal.

The present disclosure aims to enable wireless communication even when there is communication interreference by a reactive technique.

### Solution to Problem

A wireless communication system of the present disclosure performs wireless communication using a digital filter.

The digital filter is a filter for extracting a regular radio wave from a reception ratio wave that includes the regular radio wave transmitted from a regular device and an interference radio wave transmitted from an irregular device.

The wireless communication system includes:
a first regular device to transmit two first dummy radio waves at different timings;
a second regular device to transmit a second dummy radio wave at the same timing as the transmission of one of the first dummy radio waves, and to transmit the second dummy radio wave at a different timing from the transmission of the other of the first dummy radio waves; and
a partner device to receive a reception radio wave which is the sum of the first dummy radio wave, the second dummy radio wave, and the interference radio wave, to receive a reception radio wave which is the sum of the first dummy radio wave and the interference radio wave, to receive a reception radio wave which is the sum of the second dummy radio wave and the interference radio wave, and to create a first filter which is the digital filter for communicating with the first regular device and a second filter which is the digital filter for communicating with the second regular device, based on the received three reception radio waves.

### Advantageous Effects of Invention

According to the present disclosure, wireless communication is possible even when there is communication interference by a reactive technique.

### BRIEF DESCRIPTION OF DRAWINGS

FIG. 1 is a configuration diagram of a wireless communication system 100 according to Embodiment 1.

FIG. 2 is a configuration diagram of a partner device 200 according to Embodiment 1.

FIG. 3 is a functional configuration diagram of the partner device 200 according to Embodiment 1.

FIG. 4 is a configuration diagram of a regular device 300 according to Embodiment 1.

FIG. 5 is a functional configuration diagram of the regular device 300 according to Embodiment 1.

FIG. 6 is a flowchart of a wireless communication method according to Embodiment 1.

FIG. 7 is a flowchart of step S110 according to Embodiment 1.

FIG. 8 a sequence diagram of step S110 according to Embodiment 1.

FIG. 9 is a flowchart of step S120 according to Embodiment 1.

FIG. 10 is a sequence diagram of step S120 according to Embodiment 1.

FIG. 11 is a configuration diagram of the wireless communication system 100 according to a first example of the embodiment.

FIG. 12 is a configuration diagram of the partner device 200 according to a second example of the embodiment.

FIG. 13 is a flowchart of the wireless communication method according to the second example of the embodiment.

FIG. 14 is a flowchart of the wireless communication method according to a third example of the embodiment.

FIG. 15 is a configuration diagram of the wireless communication system 100 according to a fourth example of the embodiment.

FIG. 16 is a flowchart of step S110 according to the fourth example of the embodiment.

FIG. 17 is a flowchart of step S110 according to a fifth example of the embodiment.

FIG. 18 is a configuration diagram of the wireless communication system 100 according to Embodiment 2.

FIG. 19 is a configuration diagram of the partner device 200 according to Embodiment 2.

FIG. 20 is a configuration diagram of the regular device 300 according to Embodiment 2.

FIG. 21 is a flowchart of the wireless communication method according to Embodiment 2.

FIG. 22 is a flowchart of step S210 according to Embodiment 2.

FIG. 23 is a relation diagram between the partner device 200 and the regular device 300 according to Embodiment 2.

FIG. 24 is a hardware configuration diagram of the partner device 200 according to the embodiments.

FIG. 25 is a hardware configuration diagram of the regular device 300 according to the embodiments.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in the diagrams mainly indicate flows of data or flows of processes.

### Embodiment 1

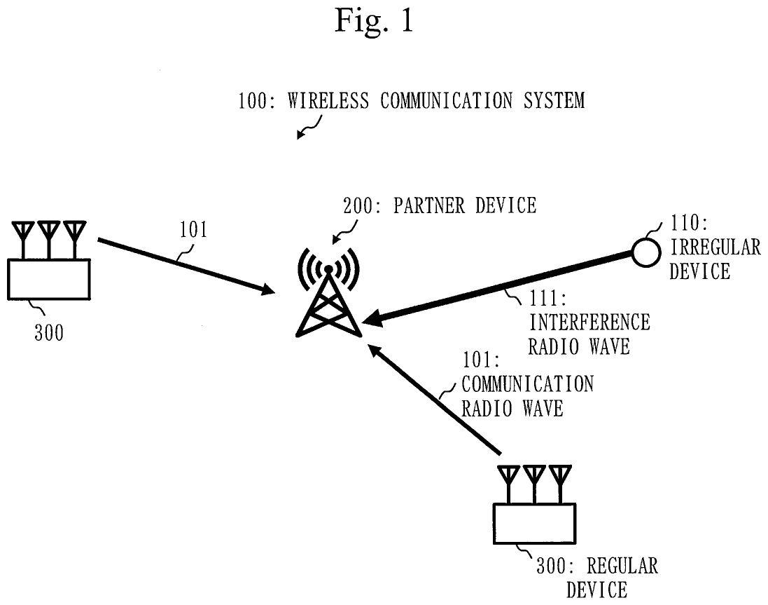

A wireless communication system 100 will be described based on FIGS. 1 to 17.

### ***Description of Configuration***

A configuration of the wireless communication system 100 will be described based on FIG. 1.

The wireless communication system 100 is a system that performs wireless communication using a digital filter.

The wireless communication system 100 includes a partner device 200 and two pieces of regular devices 300.

The partner device 200 is a wireless device on a reception side. However, the partner device 200 may have a transmission function. A specific example of the partner device 200 is a base station. A position of the base station is fixed.

The regular device 300 is a wireless device on a transmission side. However, the regular device 300 may have a reception function. A specific example of the regular device 300 is a mobile terminal.

A radio wave transmitted from the regular device 300 is referred to as a communication radio wave 101.

The wireless device is a device that performs communication wirelessly.

An irregular device 110 is a wireless device that interferes with the wireless communication of the wireless communication system 100.

A radio wave transmitted from the irregular device 110 is referred to as an interference radio wave 111.

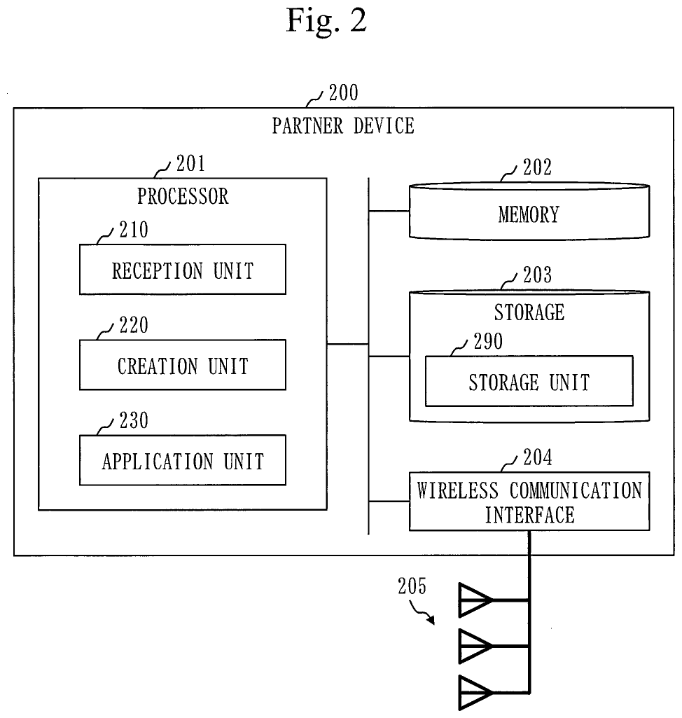

A configuration the partner device 200 will be described based on FIG. 2.

The partner device 200 is a computer that includes pieces of hardware such as a processor 201, a memory 202, a storage 203, and a wireless communication interface 204. These pieces of hardware are connected with one another through signal lines.

The processor 201 is an IC that performs arithmetic processing and controls other pieces of hardware. The processor 201 is, for example, a CPU.

IC is an abbreviation for Integrated Circuit.

CPU is an abbreviation for Central Processing Unit.

The memory 202 is a volatile or non-volatile storage device. The memory 202 is also called a main storage device or a main memory. The memory 202 is, for example, an RAM. Data stored in the memory 202 is saved in the storage 203 as necessary.

RAM is an abbreviation for Random Access Memory.

The storage 203 is a non-volatile storage device. The storage 203 is, for example, an ROM, an HDD, a flash memory, or a combination thereof. Data stored in the storage 203 is loaded into the memory 202 as necessary.

ROM is an abbreviation for Read Only Memory.

HDD is an abbreviation for Hard Disk Drive.

The wireless communication interface 204 includes a plurality of antennas 205.

The wireless communication interface 204 is a receiver and a transmitter. The wireless communication interface 204 is, for example, a communication chip or an NIC. Communication of the partner device 200 is performed using the wireless communication interface 204.

NIC is abbreviation for Network Interface Card.

The partner device 200 includes elements such as a reception unit 210, a creation unit 220, and an application unit 230. These elements are implemented by software.

The storage 203 stores a wireless communication program for causing the computer to function as the reception unit 210, the creation unit 220, and the application unit 230. The wireless communication program is loaded into the memory 202 and executed by the processor 201.

The storage 203 further stores an OS. At least a part of the OS is loaded into the memory 202 and executed by the processor 201.

The processor 201 executes the wireless communication program while executing the OS.

OS is an abbreviation for Operating System.

A storage unit 290 sores input/output data of the wireless communication program.

The storage 203 functions as the storage unit 290. However, a storage device such as the memory 202, a register in the processor 201, and a cache memory in the processor 201 may function as the storage unit 290 in place of the storage 203 or together with the storage 203.

The partner device 200 may include a plurality of processors as an alternative to the processor 201.

The wireless communication program can be recorded (stored) in a computer readable format in a non-volatile recording medium such as an optical disc or a flash memory.

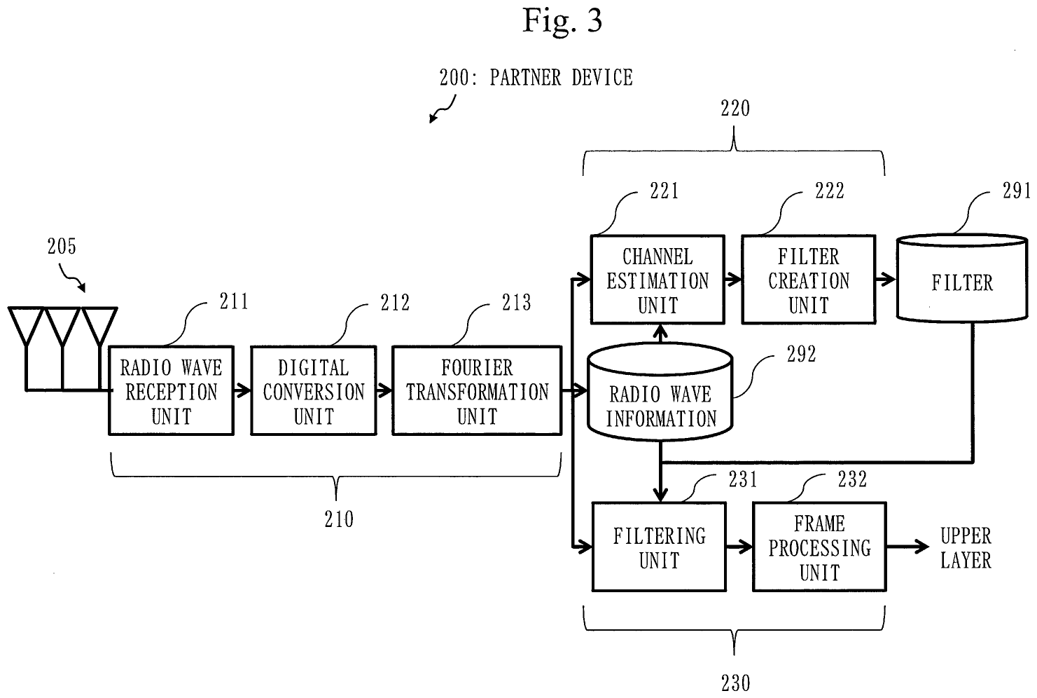

A functional configuration of the partner device 200 will be described based on FIG. 3.

The reception unit 210 includes a radio wave reception unit 211, a digital conversion unit 212, and a Fourier transformation unit 213.

The creation unit 220 includes a channel estimation unit 221 and a filter creation unit 222.

The application unit 230 includes a filtering unit 231 and a frame processing unit 232.

The storage unit 290 stores data such as a filter 291 and radio wave information 292. These pieces of data will be described below.

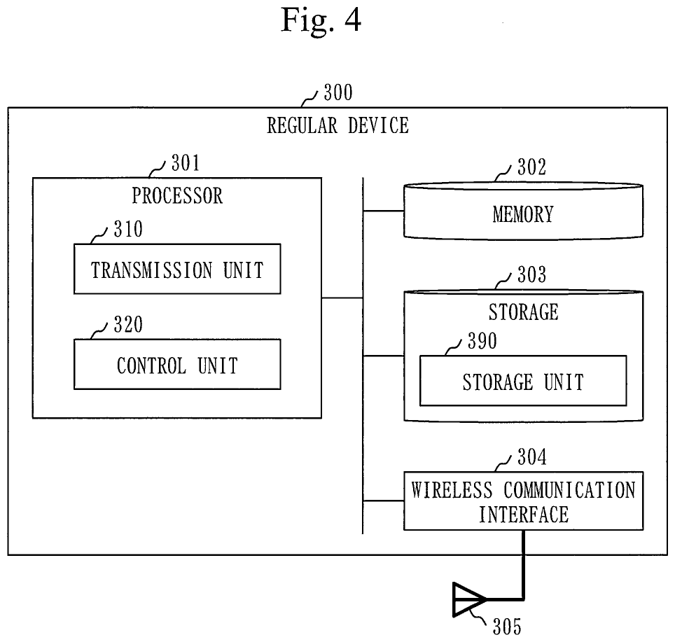

A configuration of the regular device 300 will be described based on FIG. 4.

The regular device 300 is a computer that includes pieces of hardware such as a transmission unit 310 and a control unit 320. These pieces of hardware are connected with one another through signal lines.

The processor 301 is an IC that performs arithmetic processing and controls other pieces of hardware. The processor 301 is, for example, a CPU.

A memory 302 is a volatile or non-volatile storage device. The memory 302 is also called a main storage device or a main memory. The memory 302 is, for example, an RAM. Data stored in the memory 302 is saved in a storage 303 as necessary

The storage 303 is a non-volatile storage device. The storage 303 is, for example, an ROM, an HDD, a flash memory, or a combination thereof. Data stored in the storage 303 is loaded into the memory 302 as necessary.

A wireless communication interface 304 includes an antenna 305. The wireless communication interface 304 is a receiver and a transmitter. The wireless communication interface 304 is, for example, a communication chip or an NIC. Communication of the regular device 300 is performed using the wireless communication interface 304.

The regular device 300 includes elements such as the transmission unit 310 and the control unit 320. These elements are implemented by software.

The storage 303 stores a wireless communication program for causing the computer to function as the transmission unit 310 and the control unit 320. The wireless communication program is loaded into the memory 302 and executed by the processor 301.

The storage 303 further sores an OS. At least a part of the OS is loaded into the memory 302 and executed by the processor 301.

The processor 301 executes the wireless communication program while executing the OS.

A storage unit 390 stores input/output data of the wireless communication program.

The storage 303 functions as the storage unit 390. However, a storage device such as the memory 302, a register in the processor 301, and a cache memory in the processor 301 may function as the storage unit 390 in place of the storage 303 or together with the storage 303.

The regular device 300 may include a plurality of processors as an alternative to the processor 301.

The wireless communication program can be recorded (stored) in a computer readable format in a non-volatile recording medium such as an optical disc or a flash memory.

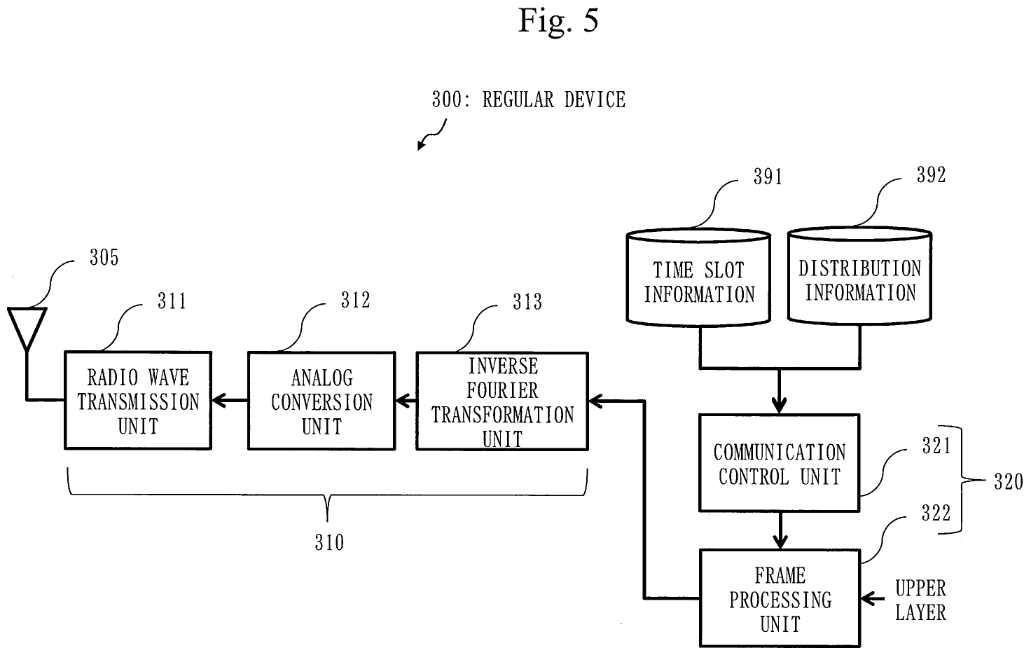

A functional configuration of the regular device 300 will be described based on FIG. 5.

The transmission unit 310 includes a radio wave transmission unit 311, an analog conversion unit 312, and an inverse Fourier transformation unit 313.

The control unit 320 includes a communication control unit 321 and a frame processing unit 322.

The storage unit 390 stores data such as time slot information 391 and distribution information 392. These pieces of data will be described below. The storage unit 290 of the partner device 200 also stores the time slot information 391 and the distribution information 392.

### ***Description of Operation***

A procedure of operation of the wireless communication system 100 is equivalent to a wireless communication method.

The partner device 200 is capable of MIMO communication.

The partner device 200 and the two pieces of regular devices 300 are time synchronized.

The irregular device 110 performs communication interference by a reactive technique. In the reactive technique, communication of the communication radio wave 101 is monitored, and the interference radio wave 111 is transmitted when the communication radio wave 101 is detected.

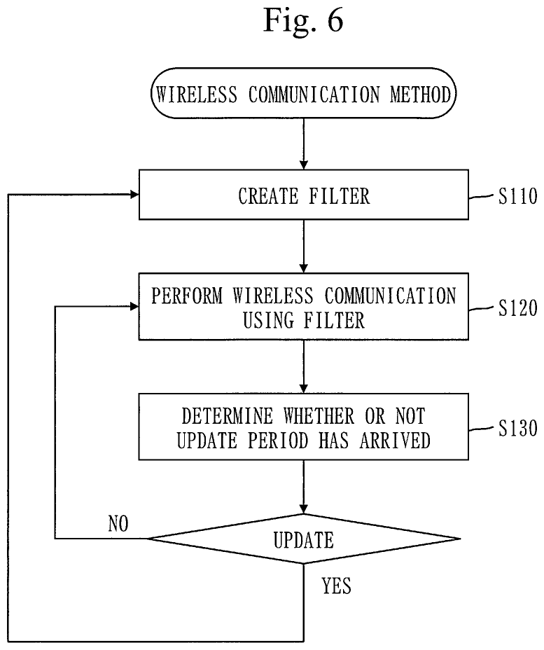

The wireless communication method will be described based on FIG. 6.

One of the regular devices 300 is referred to as a first regular device 300 and the other of the regular devices 300 is referred to as a second regular device 300.

In step S110, the partner device 200 creates a first filter 291 and a second filter 291.

The first filter 291 is the filter 291 for communicating with the first regular device 300.

The second filter 291 is the filter 291 for communicating with the second regular device 300.

The filter 291 is a digital filter for extracting a regular radio wave from a reception radio wave that includes the regular radio wave and the interference radio wave 111.

The regular radio wave is the communication radio wave 101 that includes a regular frame.

The regular frame is a communication frame for the purpose of communication.

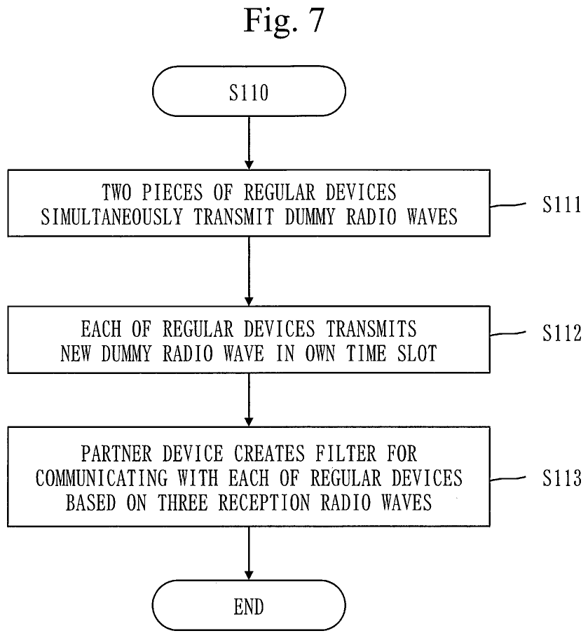

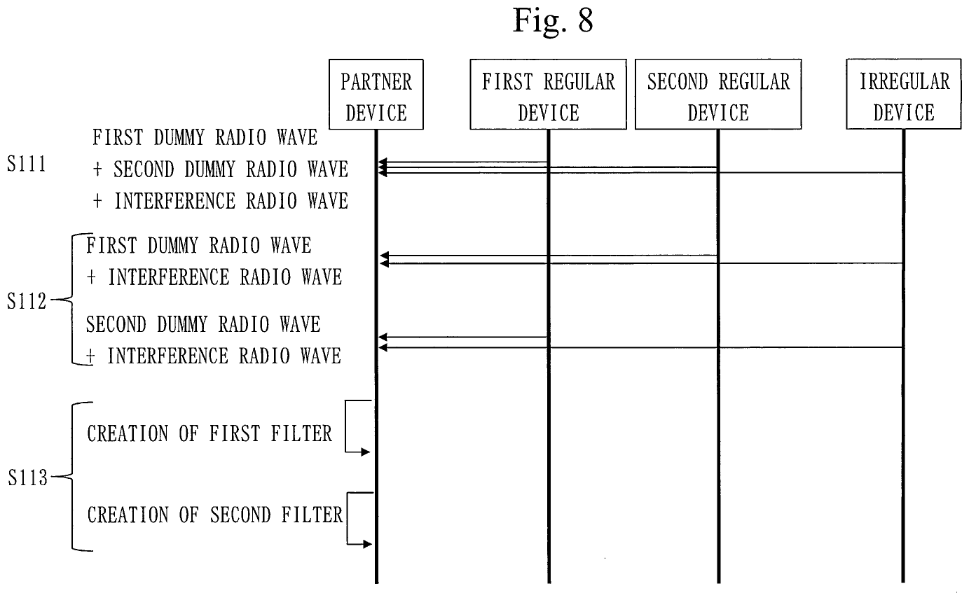

The procedure of step S110 will be described based on FIGS. 7 and 8.

In step S111, the two regular devices 300 simultaneously transmit dummy radio waves.

Specifically, the first regular device 300 transmits a first dummy radio wave, and the second regular device 300 transmits a second dummy radio wave at the same timing as the transmission of the first dummy radio wave.

The dummy radio wave is the communication radio wave 101 that includes a dummy frame.

The dummy frame is a dummy communication frame.

The dummy radio wave is transmitted as follows.

First, the frame processing unit 322 generates the dummy frame.

Next, the inverse Fourier transformation unit 313 uses the dummy frame as a dummy signal, and processes the dummy signal by the inverse fast Fourier transformation.

Next, the analog conversion unit 312 converts the processed dummy signal from a digital signal to an analog signal.

Then, the radio wave transmission unit 311 emits the converted dummy signal from the antenna 305, as the dummy radio wave.

The irregular device 110 detects the first dummy radio wave and the second dummy radio wave, and transmits the interference radio wave 111.

The partner device 200 receives a reception radio wave which is the sum of the first dummy radio wave, the second radio wave, and the interference radio wave 111.

The reception radio wave is processed as follows.

First, the radio wave reception unit 211 receives the reception radio wave.

Next, the digital conversion unit 212 uses the reception radio wave as a reception signal, and converts the reception signal from an analog signal to a digital signal.

Next, the Fourier transformation unit 213 processes the reception signal by the fast Fourier transformation.

Then, the Fourier transformation unit 213 uses the processed reception signal as the radio wave information 292, and stores the radio wave information 292 in the storage unit 290.

In S112, each of the regular devices 300 transmits a new dummy radio wave in own time slot. The own time slot means an assigned time slot.

Specifically, the first regular device 300 transmits the new first dummy radio wave in a first time slot, and the second regular device 300 transmits the new second dummy radio wave in a second time slot.

The first time slot is a time slot assigned to the first regular device 300.

The second time slot is a time slot assigned to the second regular device 300, and has a different timing from that of the first time slot.

The own time slot is determined by the communication control unit 321.

The communication control unit 321 determines the own time slot based on the time slot information 391 and the distribution information 392.

The time slot information 391 indicates a timing of each time slot.

The distribution information 392 indicates a number of the time slot assigned to each of the regular devices 300.

In the first time slot, the irregular device 110 detects the new first dummy radio wave, and transmits the interference radio wave 111.

In the second time slot, the irregular device 110 detects the new second dummy radio wave, and transmits the interference radio wave 111.

In the first time slot, the partner device 200 receives a reception radio wave which is the sum of the first dummy radio wave and the interference radio wave 111.

In the second time slot, the partner device 200 receives a reception radio wave which is the sum of the new second dummy radio wave and the interference radio wave 111.

Each reception radio wave is processed in the same way as in step S111.

Steps S111 and S112 may be executed in the reverse order.

In step S113, the partner device 200 creates the filter 291 for communicating with each of the regular devices 300, based on the three reception radio waves in steps S111 and S112. Specifically, the first filter 291 and the second filter 291 are created.

The filter 291 is created by the following procedure.

First, the channel estimation unit 221 estimates channel information on each of the first regular device 300 and the second regular device 300 based on three pieces of the radio wave information 292 stored in the storage unit 290.

The channel information is a matrix having complex numbers as components, and expresses how the amplitude and phase of a communicated radio wave have changed.

A specific example of an estimation technique is an MMSE technique. The MMSE technique is one of estimation techniques in an MIMO system, and is disclosed in Non-Patent Literature 1.

In Non-Patent Literature 1, the channel information on each of a regular terminal and an irregular device based on the sum of a radio wave transmitted from the regular terminal and a radio wave transmitted from the irregular device, and the radio wave transmitted from the irregular device.

On the other hand, the channel estimation unit 221 estimates the channel information on each of the first regular device 300 and the second regular device 300 as follows.

The channel estimation unit 221 estimates the channel information on the first regular device 300 and the channel information on a set of the second regular device 300 and the irregular device 110, based on zeroth radio wave information 292 and second radio wave information 292.

The channel estimation unit 221 estimates the channel information on the second regular device 300 and the channel information on a set of the first regular device 300 and the irregular device 110, based on the zeroth radio wave information 292 and first radio wave information 292.

The zeroth radio wave information 292 is the radio wave information 292 on the reception radio wave which is the sum of the first dummy radio wave, the second dummy radio wave, and the interference radio wave 111.

The first radio wave information 292 is the radio wave information 292 on the reception radio wave which is the sum of the first dummy radio wave and the interference radio wave 111.

The second radio wave information 292 is the radio wave information 292 on the reception radio wave which is the sum of the second dummy radio wave and the interference radio wave 111.

Next, the filter creation unit 222 creates the first filter 291 based on the channel information on the first regular device 300.

Further, the filter creation unit 222 creates the second filter 291 based on the channel information on the second regular device 300.

A specific example of a creation method is the method disclosed in Non-Patent Literature 1. This method uses an RZF filter.

RZF is an abbreviation for Regularized Zero-Forcing.

Then, the filter creation unit 222 stores the first filter 291 and the second filter 291 in the storage unit 290.

Returning to FIG. 6, the description will be continued from step S120.

In step S120, the partner device 200 performs wireless communication, using the first filter 291 and the second filter 291.

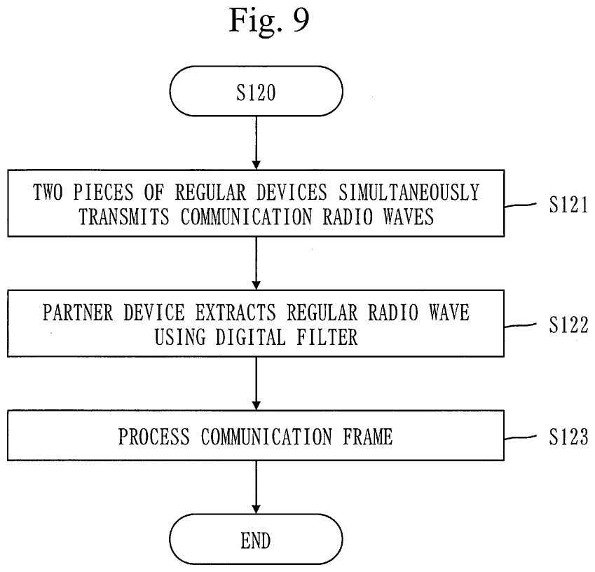

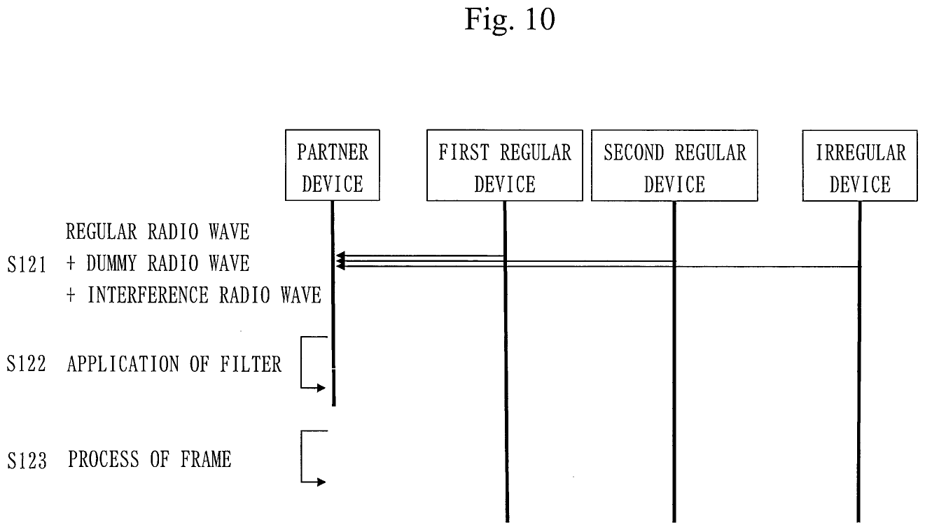

The procedure of step S120 will be described based on FIGS. 9 and 10.

In step S121, the two pieces of regular devices 300 simultaneously transmit the communication radio waves 101.

In the case of the first time slot, the first regular device 300 transmits a first regular radio wave, and the second regular device 300 transmits the second dummy radio wave.

In the case of the second time slot, the first regular device 300 transmits the first communication radio wave 101 in the second time slot, and the second regular device 300 transmits the second dummy radio wave.

The regular radio wave is transmitted as follows.

First, an upper layer generates regular data, and transmits the regular data to the frame processing unit 322.

Next, the frame processing unit 322 receives the regular data and generates a regular frame that includes the regular data.

Next, the inverse Fourier transformation unit 313 uses the regular frame as a regular signal, and processes the regular signal by the inverse fast Fourier transformation.

Next, the analog conversion unit 312 converts the processed regular signal from a digital signal to an analog signal.

Then, the radio wave transmission unit 311 emits the converted regular signal from the antenna 305, as the regular radio wave.

In the case of the first time slot, the irregular device 110 detects the first regular radio wave and the second dummy radio wave, and transmits the interference radio wave 111.

In the case of the second time slot, the irregular device 110 detects the first dummy radio wave and a second regular radio wave, and transmits the interference radio wave 111.

In the case of the first time slot, the partner device 200 receives a reception radio wave which is the sum of the first regular radio wave, the second dummy radio wave, and the interference radio wave 111.

In the case of the second time slot, the partner device 200 receives a reception radio wave which is the sum of the first dummy radio wave, the second regular radio wave, and the interference radio wave 111.

Each of the reception radio waves is processed in the same way as in step S111.

In step S122, the partner device 200 extracts the regular radio wave from the reception radio wave, using the filter 291.

In the case of the first time slot, the partner device 200 extracts the first regular radio wave from the reception radio wave, using the first filter 291. Specifically, the filtering unit 231 extracts a first regular signal from the radio wave information 292 on the reception radio wave, using the first filter 291. The first regular signal is a signal of the first regular radio wave.

In the case of the second time slot, the partner device 200 extracts the second regular radio wave from the reception radio wave, using the second filter 291. Specifically, the filtering unit 231 extracts a second regular signal from the radio wave information 292 on the reception radio wave, using the second filter 291. The second regular signal is a signal of the second regular radio wave.

In step S123, the partner device 200 processes a communication frame.

Specifically, the frame processing unit 232 uses the regular radio wave as the communication frame and decodes the communication frame, and transmits the decoded communication frame to the upper layer. Then, the upper layer receives the decoded communication frame, and processes the received communication frame.

Further, when the partner device 200 includes a transmission unit as with the regular device 300, the partner device 200 operates as follows.

The upper layer generates communication data depending on a processing result and transmits the communication data to the frame processing unit 232.

The frame processing unit 232 receives the communication data and creates a communication frame that includes the communication data.

The transmission unit emits from the antenna 205, a communication radio wave that includes the communication frame.

Returning to FIG. 6, step S130 will be described.

In step S130, the partner device 200 and each of the regular devices 300 determine whether or not an update period has arrived.

Specifically, the creation unit 220 determines whether or not a certain time has elapsed since the previous update period. Further, the control unit 320 determines whether or not the certain time has elapsed since the previous update period. The certain time is a time having a predetermined length. The certain time is, for example, one second.

When the update period has arrived, the process proceeds to step S110. Thereby, the filter 291 is updated periodically.

When the update period has not arrived, the process proceeds to step S120.

### ***Effects of Embodiment 1***

The wireless communication system 100 extends the technique of Non-Patent Literature 1, by deliberately considering the communication radio wave 101 of one of the regular devices 300, as an interference radio wave. Then, the wireless communication system 100 estimates channel information on a signal of a radio wave (the first regular radio wave) which is desired to be received, using a signal of the entire reception radio wave (the sum of the first dummy radio wave, the second dummy radio wave, and the interference radio wave 111) and a signal of the interference radio wave (the sum of the second dummy radio wave and the interference radio wave 111).

Thereby, it is possible to create a digital filter. Then, even if there is reactive communication interference by the irregular device 110, it is possible to obtain only a signal of a radio wave from the regular device 300, by applying the digital filter.

### ***Description of Examples of Embodiment***

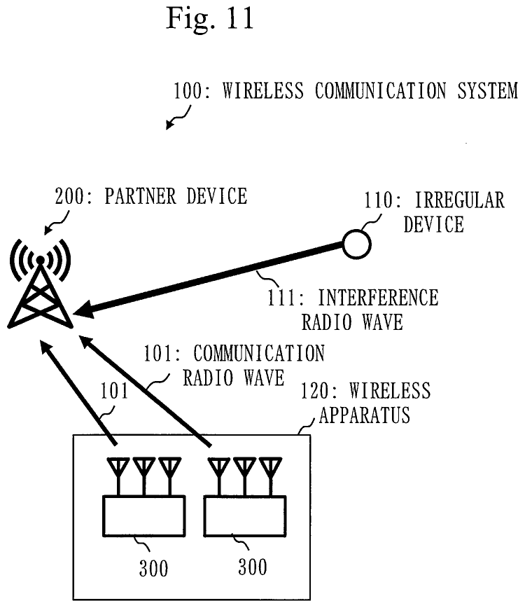

A first example of the embodiment will be described based on FIG. 11.

The wireless communication system 100 includes a wireless apparatus 120.

The wireless apparatus 120 includes two pieces of regular devices 300.

A second example of the embodiment will be described.

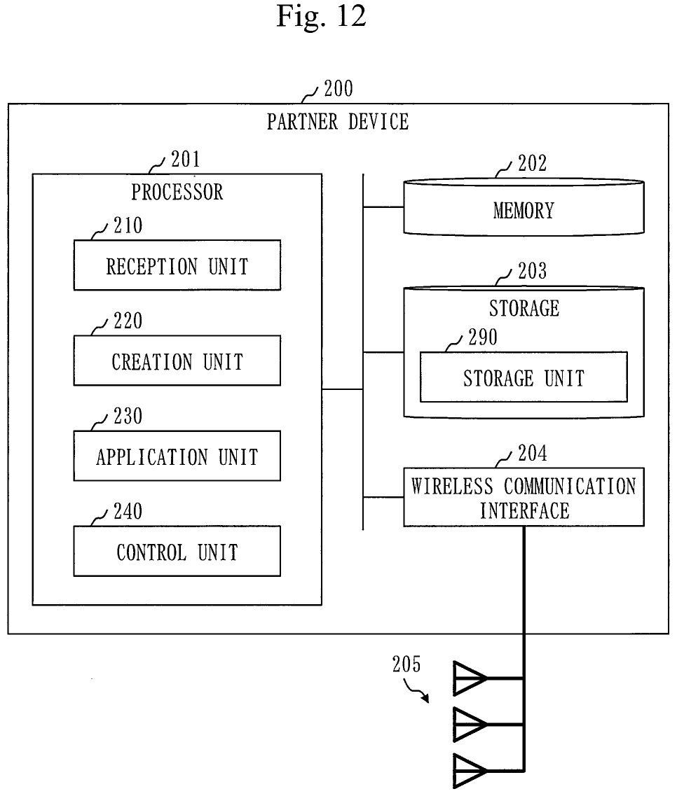

A configuration of the partner device 200 will be described based on FIG. 12.

The partner device 200 further includes an element called a control unit 240.

The wireless communication program of the partner device 200 further causes the computer to function as the control unit 240.

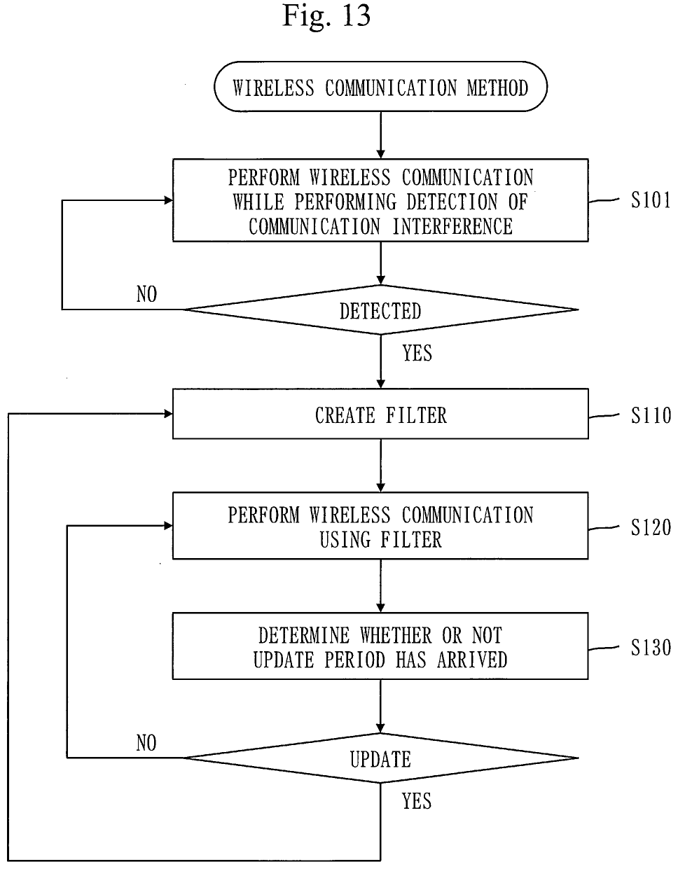

The wireless communication method will be described based on FIG. 13.

In step S101, the partner device 200 performs normal wireless communication while performing detection of communication interference. The normal wireless communication is wireless communication performed without using the filter 291.

The detection of communication interference is performed by the control unit 240. The control unit 240 inspects a communication frame, and detects the communication interference when a reception error in the communication frame continues for equal to or greater than the number of times threshold, for example. A specific example of the inspection is error detection by a CRC. The number of times threshold is, for example, 10 times. CRC is an abbreviation for Cyclic Redundancy Code. Alternatively, the control unit 240 measures the intensity of a reception radio wave, and detects the communication interference when an increase in the intensity of the reception radio wave is equal to or greater than an increased threshold. The increased threshold is. for example, 10 dBm. Alternatively, the control unit 240 measures an arrival direction of a radio wave, and detects the communication interference when a change in the arrival direction is equal to or greater than a change threshold. The change threshold is, for example. 30 degrees.

When the communication interference is detected, the control unit 240 notifies the two pieces of regular devices 300 of a timing of switching a communication technique. The control unit 240 transmits to the two pieces of regular devices 300, a pulse string corresponding to a code string shared in advance, for example. This notification technique is a technique of temporarily changing a modulation method to intensity modulation. In this notification technique, a communication bit rate significantly decreases compared to that in the commonly used modulation method such as OFDM. Therefore, this notification technique is used only at the timing of switching the communication technique. OFDM is an abbreviation for Orthogonal

### Frequency Division Multiplexing.

After the notification, the process proceeds to step S110.

A third example of the embodiment will be described. The third example of the embodiment is modification of the second example of the embodiment.

A configuration of the partner device 200 is the same as that in the second example of the embodiment.

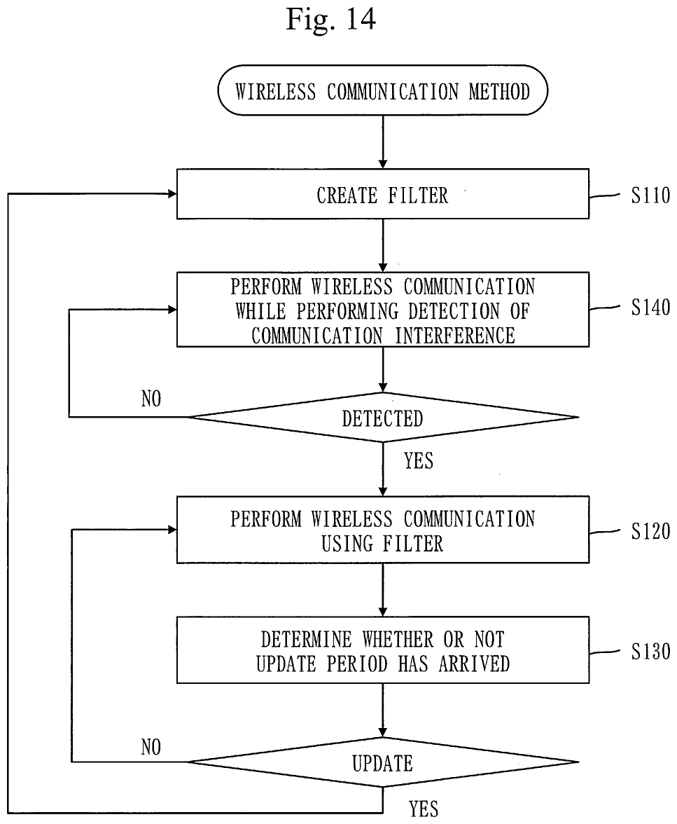

The wireless communication method will be described based on FIG. 14.

After step S110, the process proceeds to step S140.

In step S140, the partner device 200 performs normal wireless communication while performing detection of communication interference. The detection of communication interference is the same as the detection in the second example of the embodiment.

When the communication interference is detected, the process proceeds to step S120.

In the third example of the embodiment, the partner device 200 determines whether or not to apply the filter 291 depending on a communication quality. Therefore, there is no need to notify each of the regular devices 300 of the timing of switching the communication technique.

A fourth example of the embodiment will be described.

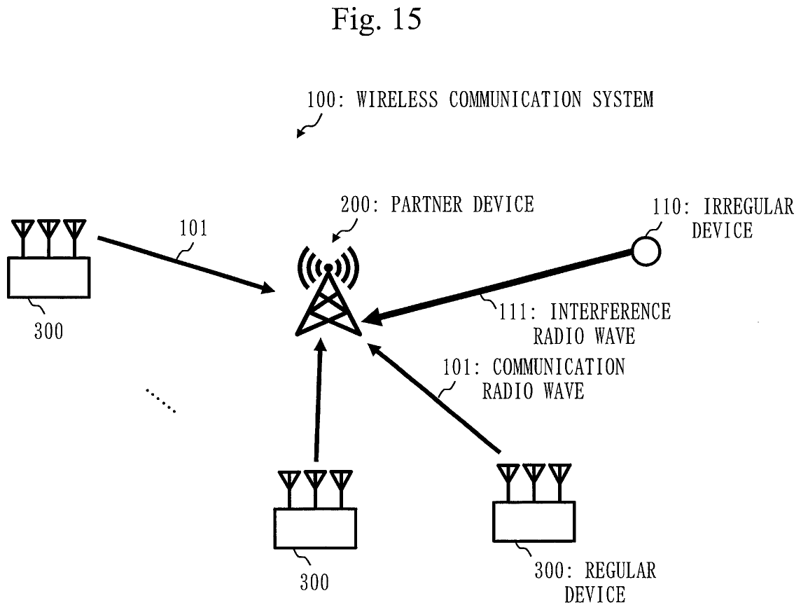

A configuration of the wireless communication system 100 will be described based on FIG. 15.

The wireless communication system 100 includes a plurality of regular devices 300. Specifically, the wireless communication system 100 includes N pieces of regular devices 300. “N” is an integer equal to or greater than 3.

A configuration of the partner device 200 is the same as that in the second example of the embodiment.

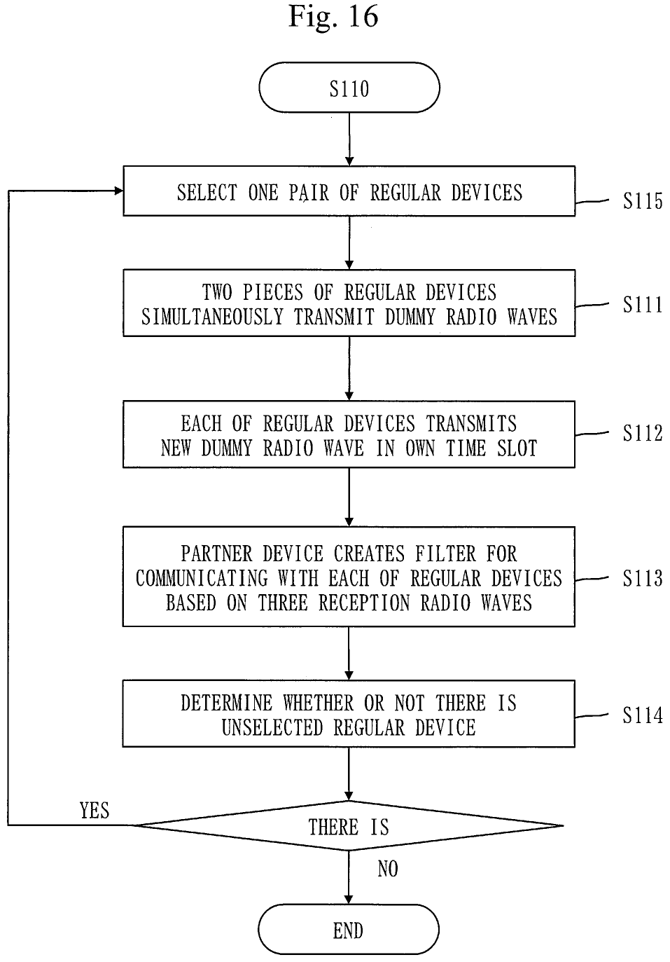

The procedure of step S110 will be described based on FIG. 16.

In step S115, the control unit 240 selects from a regular device list, a pair of regular devices that includes an unselected regular device 300. The pair of regular devices consists of two pieces of regular devices 300. The regular device list indicates the plurality of regular devices 300, and is stored in the storage unit 290.

Then, the control unit 240 performs notification to each of the regular devices 300 of the selected pair of regular devices.

Ater step S115, the process proceeds to step S111.

Steps S111 to S113 are executed for the selected pair of regular devices. That is, steps S111 to S113 are executed for one of the regular devices 300 as the first regular device 300 and the other of the regular devices 300 as the second regular device 300.

After step S113, the process proceeds to step S114.

In step S114, the control unit 240 determines whether or not there is an unselected regular device 300.

When there is the unselected regular device 300, the process proceeds to step S114.

When there is no unselected regular device 300, the process ends.

As a result, digital filters for N pieces are created.

A fifth example of the embodiment will be described. The fifth example of the embodiment is modification of the fourth example of the embodiment.

A configuration of the wireless communication system 100 is the same as the configuration in the fourth example of the embodiment. Each of the regular devices 300 is given a priority degree.

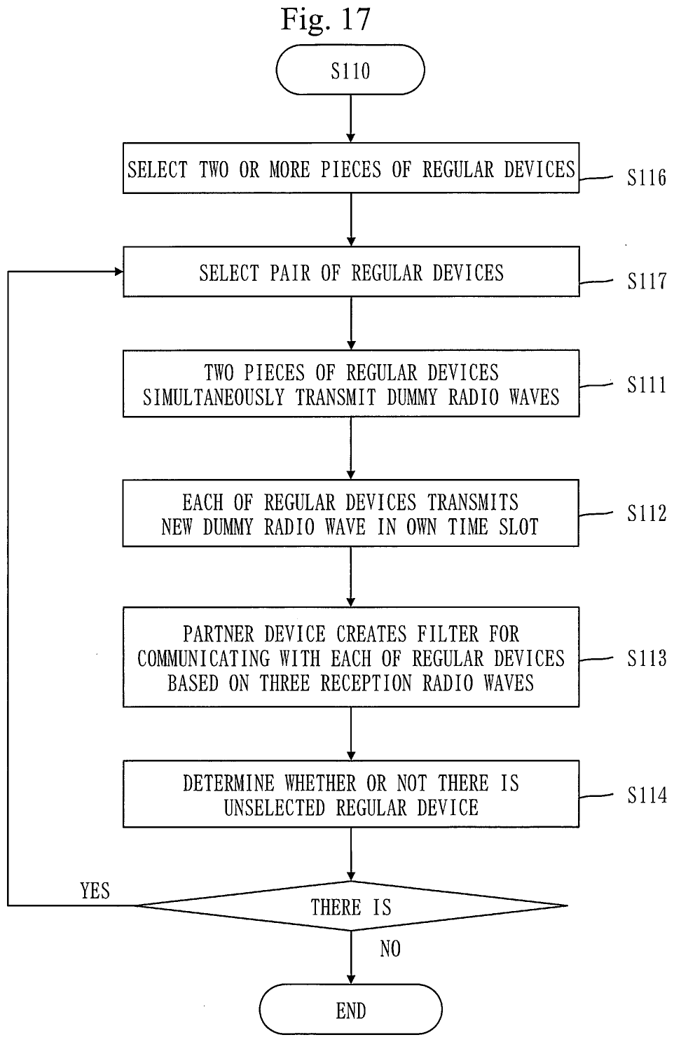

The procedure of step S110 will be described based on FIG. 17.

In step S116, the control unit 240 selects from a regular device list, two or more pieces of regular devices 300 based on the priority degree. The regular device list indicates a plurality of regular devices 300 and the priority degree of each of the regular devices 300.

Specifically, the control unit 240 selects from the N pieces of regular devices 300, K pieces of regular devices 300. “K” is an integer equal to or greater than 2 and less than N.

In step S117, the control unit 240 selects from the selected two or more pieces of regular devices 300, a pair of regular devices. Then, the control unit 240 performs notification to each of the regular devices 300 of the selected pair of regular devices.

After step S117, the process proceeds to step S111. Steps S111 to S114 are the same as the steps in the fourth example of the embodiment.

In the fifth example of the embodiment, a digital filter is created for each of the K pieces of regular devices 300 each of which has the high priority degree. A condition of creating the digital filter is shared in advance with the time slot information 391, in the partner device 200 and the plurality of regular devices 300.

Each example of the embodiment may be implemented independently or in combination with another example of the embodiment.

### Embodiment 2

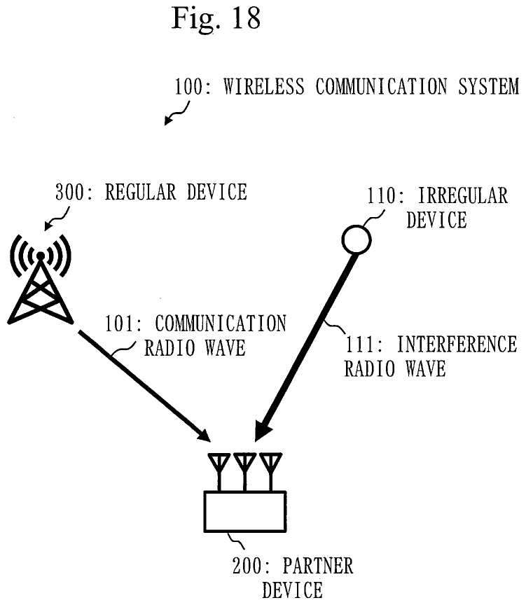

An embodiment in which the partner device 200 moves and a position of the regular device 300 is fixed will be described mainly focusing on differences from Embodiment 1, based on FIGS. 18 to 23.

### ***Description of Configuration***

A configuration of the wireless communication system 100 will be described based on FIG. 18.

The wireless communication system 100 includes the regular device 300 and one or more pieces of partner devices 200.

A position of the regular device 300 is fixed. A specific example of the regular device 300 is a base station.

The partner device 200 performs positioning while moving. A specific example of the partner device 200 is a mobile terminal.

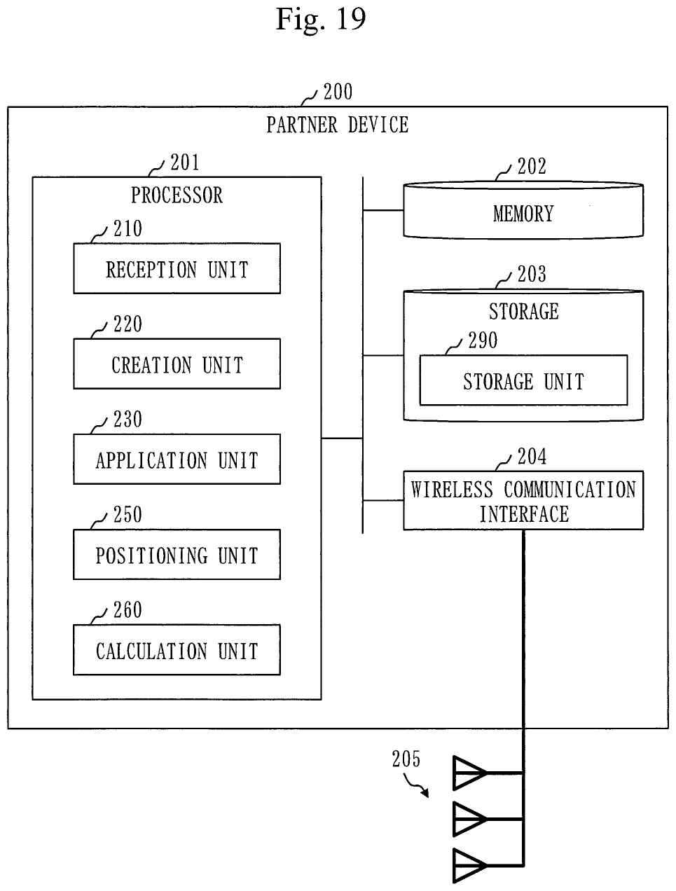

A configuration of the partner device 200 will be described based on FIG. 19.

The partner device 200 further includes elements such as a positioning unit 250 and a calculation unit 260.

The wireless communication program of the partner device 200 further causes the computer to function as the positioning unit 250 and the calculation unit 260.

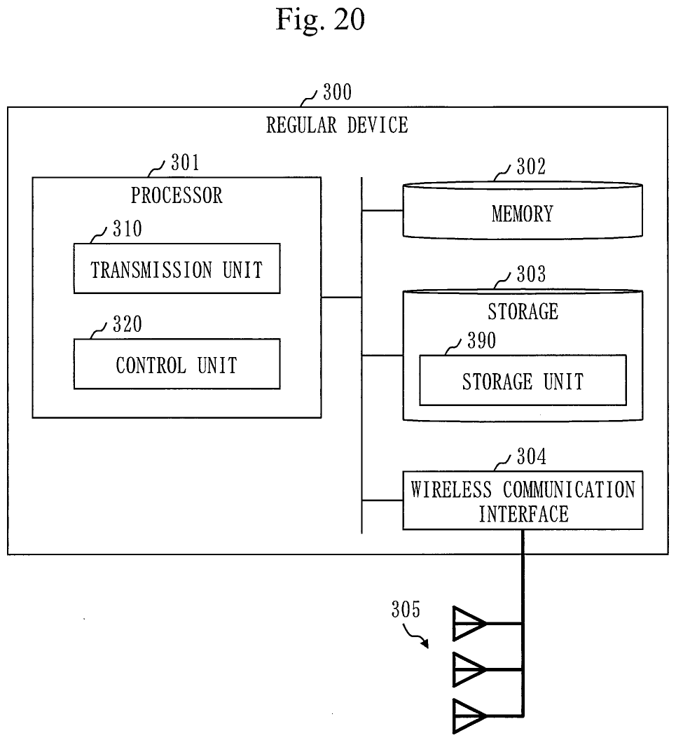

A configuration of the regular device 300 will be described based on FIG. 20.

The regular device 300 includes a plurality of antennas 305.

### ***Description of Operation***

In the partner device 200, the storage unit 290 stores position information on the regular device 300. Further, the positioning unit 250 periodically obtains position information on the partner device 200 through positioning. A specific example of a positioning technique is a technique using a GPS. GPS is an abbreviation for Global Positioning System.

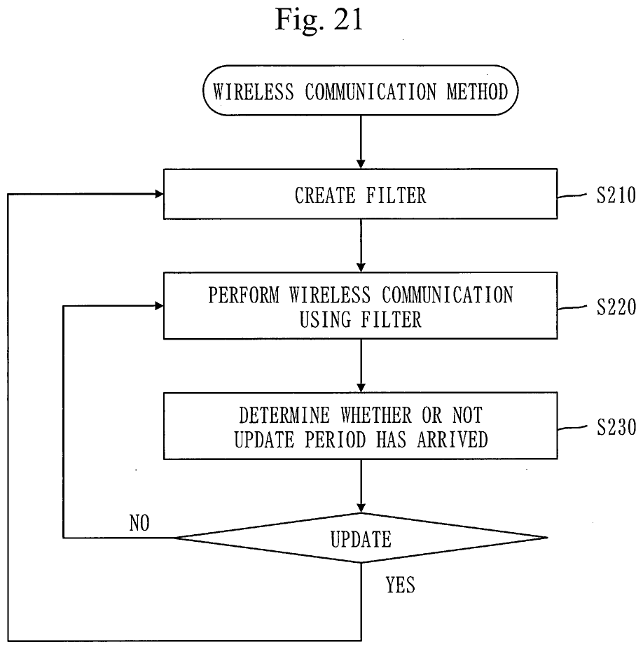

The wireless communication method will be described based on FIG. 21.

In step S210, the partner device 200 creates the filter 291.

Steps S220 and S230 are the same as steps S120 and S130 in Embodiment 1.

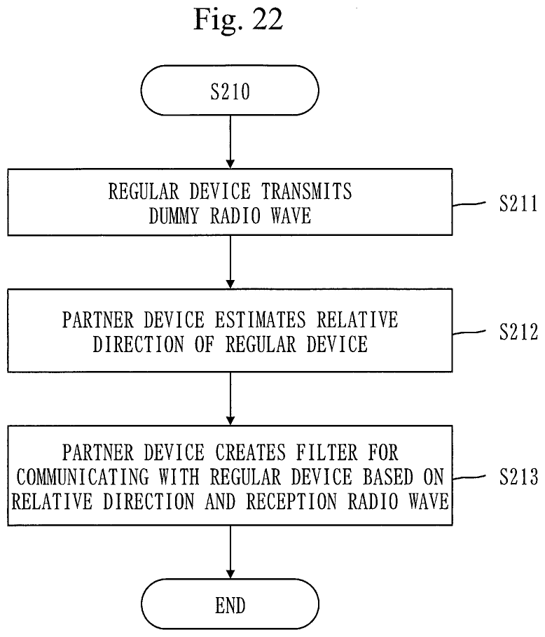

The procedure of step S210 will be described based on FIG. 22.

In step S211, the regular device 300 transmits a dummy radio wave.

The irregular device 110 detects the dummy radio wave and transmits the interference radio wave 111.

The partner device 200 receives a reception radio wave which is the sum of the dummy radio wave and the interference radio wave 111.

In step S212, the calculation unit 260 calculates a relative direction of the regular device 300 based on the position information on the partner device 200 and the position information on the regular device 300. The relative direction of the regular device 300 is a direction in which the regular device 300 is positioned with the partner device 200 as a base point.

In step S213, the creation unit 220 creates the filter 291 for communicating with the regular device 300 based on the relative direction and the reception radio wave.

The filter 291 is created by the following procedure.

First, the channel estimation unit 221 estimates channel information on the regular device 300 based on the relative direction and the radio wave information 292. An estimation technique will be described below.

Then, the filter creation unit 222 creates the filter 291 based on the channel information on the regular device 300.

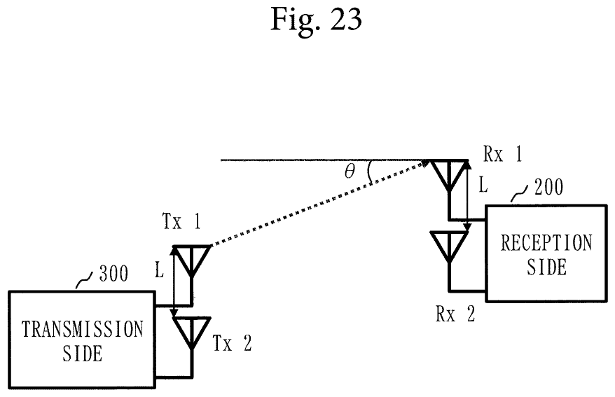

The estimation technique of the channel information on the regular device 300 will be described based on FIG. 23.

There is no obstacle between the partner device 200 and the regular device 300.

The partner device 200 includes two pieces of antennas 205. “Rx1” means a first antenna 205. “Rx2” means a second antenna 205.

The regular device 300 includes two pieces of antenna 305. “Tx1” means a first antenna 305. “Tx2” means a second antenna 305.

“L” means a distance between antennas. The distance L is known.

“θ” means an angle indicating the relative direction of the regular device 300.

A distance between the partner device 200 and the regular device 300 is sufficiently longer than the distance L. Therefore, if the communication radio wave 101 is approximated by a plane wave, the channel information in a case of the angle θ is represented by formula (1).

“j” represents an imaginary unit.

“f” represents frequency.

“c” represents the speed of light.

“α” is a complex number representing a phase change due to an attenuation rate and propagation.

$$\begin{matrix}[ Formula 1 ] & \\ [ \begin{matrix}Rx 1 \\ Rx 2\end{matrix} ] = α [ \begin{matrix}1 & {e}^{- j \frac{2 π f}{c} L sin θ} \\ {e}^{- j \frac{2 π f}{c} ( - L ) sin θ} & 1\end{matrix} ] [ \begin{matrix}Tx 1 \\ Tx 2\end{matrix} ] & ( 1 )\end{matrix}$$

The channel estimation unit 221 calculates channel information h on the regular device 300 by calculating formula (2). α is 1.

$$\begin{matrix}[ Formula 2 ] & \\ h = [ \begin{matrix}1 & {e}^{- j \frac{2 π f}{c} L sin θ} \\ {e}^{- j \frac{2 π f}{c} ( - L ) sin θ} & 1\end{matrix} ] & ( 2 )\end{matrix}$$

This means that all of subspaces which are orthogonal to the channel information h among a linear space which is formed in accordance with the channel information on the sum of the dummy signal and the interference radio wave 111 is treated as the channel information on the interference radio wave 111.

### ***Effects of Embodiment 2***

According to Embodiment 2, even if there is reactive communication interference (jamming) by the irregular device 110, only a radio wave signal from the regular device 300 can be obtained without preparing a plurality of regular devices 300.

### ***Supplement to Embodiments***

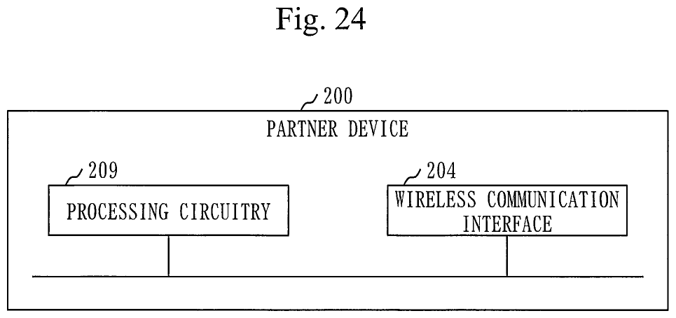

A hardware configuration of the partner device 200 will be described based on FIG. 24.

The partner device 200 includes processing circuitry 209.

The processing circuitry 209 is hardware that implements the reception unit 210, the creation unit 220, the application unit 230, the control unit 240, the positioning unit 250, and the calculation unit 260.

The processing circuitry 209 may be dedicated hardware, or may be the processor 201 that executes programs stored in the memory 202.

When the processing circuitry 209 is the dedicated hardware, the processing circuitry 209 is, for example, a single circuit, a composite circuit, a programmed processor, a parallel-programmed processor, an ASIC, an FPGA, or a combination thereof.

ASIC is an abbreviation for Application Specific Integrated Circuit.

FPGA is an abbreviation for Field Programmable Gate Array.

The partner device 200 may include a plurality of processing circuitry as an alternative to the processing circuitry 209.

In the processing circuitry 209, some functions may be implemented by dedicated hardware, and the remaining functions may be implemented by software or firmware.

In such a manner, the function of the partner device 200 can be implemented by hardware, software, firmware, or a combination thereof.

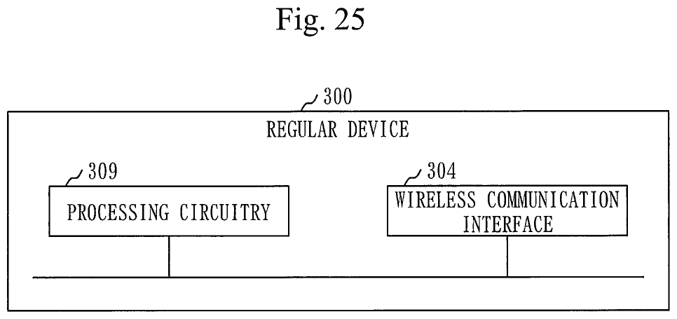

A hardware configuration of the regular device 300 will be described based on FIG. 25.

The regular device 300 includes processing circuitry 309.

The processing circuitry 309 is hardware that implements the transmission unit 310 and the control unit 320.

The processing circuitry 309 may be dedicated hardware, or may be the processor 301 that executes programs stored in the memory 302.

When the processing circuitry 309 is the dedicated hardware, the processing circuitry 309 is, for example, a single circuit, a composite circuit, a programmed processor, a parallel-programmed processor, an ASIC, an FPGA, or a combination thereof.

The regular device 300 may include a plurality of processing circuitry as an alternative to the processing circuitry 309.

In the processing circuitry 309, some functions may be implemented by dedicated hardware, and the remaining functions may be implemented by software or firmware.

In such a manner, the function of the regular device 300 can be implemented by hardware, software, firmware, or a combination thereof.

Each of the embodiments is an example of a preferred embodiment and is not intended to limit the technical scope of the present disclosure. Each of the embodiments may be implemented partially, or may be implemented in combination with another embodiment. The procedures described using the flowcharts or the like may be modified as appropriate.

“Unit” of each of the elements of the partner device 200 and the regular device 300 may be interpreted as “process”, “step”, “circuit”, or “circuitry”.

### REFERENCE SIGNS LIST

100: wireless communication system; 101: communication radio wave; 110: irregular device; 111: interference radio wave; 120: wireless apparatus; 200: partner device; 201: processor; 202: memory; 203: storage; 204: wireless communication interface; 205: antenna; 209: processing circuitry; 210: reception unit; 211: radio wave reception unit; 212: digital conversion unit; 213: Fourier transformation unit; 220: creation unit; 221: channel estimation unit; 222: filter creation unit; 230: application unit; 231: filtering unit; 232: frame processing unit; 240: control unit; 250: positioning unit; 260: calculation unit; 290: storage unit; 291: filter; 292: radio wave information; 300: regular device; 301: processor; 302: memory; 303: storage; 304: wireless communication interface; 305: antenna; 309: processing circuitry; 310: transmission unit; 311: radio wave transmission unit; 312: analog conversion unit; 313: inverse Fourier transformation unit; 320: control unit; 321: communication control unit; 322: frame processing unit; 390: storage unit; 391: time slot information; 392: distribution information.

1. A wireless communication system that performs wireless communication using a digital filter, wherein
the digital filter is a filter for extracting a regular radio wave from a reception radio wave that includes the regular radio wave transmitted from a regular device and an interference radio wave transmitted from an irregular device, the wireless communication system comprising:
a first regular device to transmit two first dummy radio waves at different timings;
a second regular device to transmit a second dummy radio wave at the same timing as the transmission of one of the first dummy radio waves, and to transmit the second dummy radio wave at a different timing from the transmission of the other of the first dummy radio waves; and
a partner device to receive a reception radio wave which is the sum of the first dummy radio wave, the second dummy radio wave, and the interference radio wave, to receive a reception radio wave which is the sum of the first dummy radio wave and the interference radio wave, to receive a reception radio wave which is the sum of the second dummy radio wave and the interference radio wave, and to create a first filter which is the digital filter for communicating with the first regular device and a second filter which is the digital filter for communicating with the second regular device, based on the received three reception radio waves.

2. The wireless communication system according to claim 1, wherein
the first regular device transmits a first regular radio wave in a first time slot, and transmits the first dummy radio wave in a second time slot,
the second regular device transmits the second dummy ratio wave in the first time slot, and transmits a second regular radio wave in the second time slot, and
the partner device extracts the first regular radio wave from a reception radio wave which is the sum of the first regular radio wave, the second dummy radio wave, and the interference radio wave, using the first filter in the first time slot, and
extracts the second regular radio wave from a reception radio wave which is the sum of the first dummy radio wave, the second regular radio wave, and the interference radio wave, using the second filter in the second time slot.

3. The wireless communication system according to claim 1, wherein
the partner device estimates channel information on the second regular device based on the reception radio wave which is the sum of the first dummy radio wave, the second dummy radio wave, and the interference radio wave and the reception radio wave which is the sum of the first dummy radio wave and the interference radio wave, and creates the second filter based on the estimated channel information, and
estimates channel information on the first regular device based on the reception radio wave which is the sum of the first dummy radio wave, the second dummy radio wave, and the interference radio wave and the reception radio wave which is the sum of the second dummy radio wave and the interference radio wave, and creates the first filter based on the estimated channel information.

4. The wireless communication system according to claim 1, wherein
the first regular device and the second regular device are moving wireless devices, and
the partner device updates the first filter and the second filter at each update period.

5. The wireless communication system according to claim 1, wherein
the wireless communication system comprises a wireless apparatus, and
the wireless apparatus includes the first regular device and the second regular device.

6. The wireless communication system according to claim 1, wherein
the partner device performs detection of communication interference, and performs notification to the first regular device and the second regular device for creating the first filter and the second filter when the communication interference is detected.

7. The wireless communication system according to claim 1, wherein
the partner device performs detection of communication interference, and performs communication using the first filter and the second filter when the communication interference is detected.

8. The wireless communication system according to claim 1, wherein
the wireless communication system comprises a plurality of regular devices, and
the partner device selects in sequence from the plurality of regular devices, a pair of regular devices that consists of two pieces of regular devices, and creates the first filter and the second filter for each pair of regular devices, by using one of the regular devices as the first regular device and the other of the regular devices as the second regular device.

9. The wireless communication system according to claim 1, wherein
the wireless communication system comprises a plurality of regular devices each of which is given a priority degree, and
the partner device selects from the plurality of regular devices, two or more pieces of regular devices based on the priority degree of each of the plurality of regular devices, selects in sequence from the two or more pieces of regular devices, a pair of regular devices that consists of two pieces of regular devices, and creates the first filter and the second filter for each pair of regular devices, by using one of the regular devices as the first regular device and the other of the regular devices as the second regular device.

10. A wireless communication method of performing wireless communication using a digital filter, wherein
the digital filter is a filter for extracting a regular radio wave from a reception radio wave that includes the regular radio wave transmitted from a regular device and an interference radio wave transmitted from an irregular device, the wireless communication method comprising:
by a first regular device, transmitting two first dummy radio waves at different timings;
by a second regular device, transmitting a second dummy radio wave at the same timing as the transmission of one of the first dummy radio waves, and transmitting the second dummy radio wave at a different timing from the transmission of the other of the first dummy radio waves; and
by a partner device, receiving a reception radio wave which is the sum of the first dummy radio wave, the second dummy radio wave, and the interference radio wave, receiving a reception radio wave which is the sum of the first dummy radio wave and the interference radio wave, receiving a reception radio wave which is the sum of the second dummy radio wave and the interference radio wave, and creating a first filter which is the digital filter for communicating with the first regular device and a second filter which is the digital filter for communicating with the second regular device, based on the received three reception radio waves.

11. A wireless communication system that performs wireless communication using a digital filter, wherein
the digital filter is a filter for extracting a regular radio wave from a reception radio wave which is the sum of the regular radio wave transmitted from a regular device and an interference radio wave transmitted from an irregular device, the wireless communication system comprising:
a regular device whose position is fixed; and
a partner device to perform positioning while moving, wherein
the regular device transmits a dummy signal, and
the partner device receives a reception radio wave which is the sum of the dummy signal and the interference radio wave, calculates a relative direction of the regular device based on own position information and position information on the regular device, and creates the digital filter based on the calculated relative direction and the received reception radio wave.

12. The wireless communication system according to claim 11, wherein
the regular device transmits a regular radio wave, and
the partner device extracts the regular radio wave from a reception radio wave which is the sum of the regular radio wave and the interference radio wave, using the digital filter.

13. The wireless communication system according to claim 11, wherein
the partner device estimates channel information on the regular device based on the relative direction and the reception radio wave which is the sum of the dummy signal and the interference radio wave, and creates the digital filter based on the estimated channel information.

14. A wireless communication method of a wireless communication system that performs wireless communication using a digital filter, wherein
the digital filter is a filter for extracting a regular radio wave from a reception radio wave which is the sum of the regular radio wave transmitted from a regular device and an interference radio wave transmitted from an irregular device, and
the wireless communication system comprises;
a regular device whose position is fixed; and
a partner device to perform positioning while moving, wherein
the regular device transmits a dummy signal, and
the partner device receives a reception radio wave which is the sum of the dummy signal and the interference radio wave, calculates a relative direction of the regular device based on own position information and position information on the regular device, and creates the digital filter based on the calculated relative direction and the received reception radio wave.
